(19) United States
(12) Patent Application Publication
(10) Pub. No.: US 2015/0108798 A1
(43) Pub. Date: Apr. 23, 2015

(54) SEAT-MOUNTED SUPPORTS FOR PERSONAL ELECTRONIC DEVICES, AND ASSOCIATED SYSTEMS AND METHODS

(71) Applicant: AeroCents, LLC, Black Diamond, WA (US)

(72) Inventor: William L. Boyer, JR., Black Diamond, WA (US)

(21) Appl. No.: 14/341,614

(22) Filed: Jul. 25, 2014

Related U.S. Application Data
(60) Provisional application No. 61/859,117, filed on Jul. 26, 2013.
(60) Provisional application No. 61/992,803, filed on May 13, 2014.

(51) Int. Cl. B60R 11/02; B64D 11/06; B60N 3/00; B60N 2/44

(52) U.S. Cl. CPC B60R 11/0252; B60N 2/44; B64D 11/0638; B60N 3/004; B60R 2011/0015
USPC 297/163; 297/188.05; 248/447.1

(57) ABSTRACT

The present technology relates generally to seat-mounted supports for personal electronic devices (“PEDs”), and associated systems and methods. Particular embodiments are directed to tablet or smartphone supports for mounting on an airplane seat. In some embodiments, a support system for restraining a PED includes a first panel configured for attachment to an airplane seat and a second panel having at least one restraining feature configured to restrain the PED against the second panel. The system further includes an intermediate portion pivotably connecting the first panel to the second panel. The system can include complementary engagement features on the first and second panels to adjust the angle of the first panel relative to the second panel. For example, in some embodiments, the first panel can pivot between a first position parallel to the second panel and a second position non-parallel to the second panel.

### CROSS REFERENCE TO RELATED APPLICATIONS

This non-provisional patent application hereby claims the benefit of and priority to U.S. Provisional Patent Application No. 61/859,119, titled Seat-Mounted Supports for Personal Electronic Devices, and Associated Systems and Methods, filed Jul. 26, 2013, and U.S. Provisional Patent Application No. 61/992,803, titled Seat-Mounted Supports for Personal Electronic Devices, and Associated Systems and Methods, filed May 13, 2014, which are hereby incorporated in their entireties by reference thereto.

### TECHNICAL FIELD

The present technology relates generally to seat-mounted supports for personal electronic devices, and associated systems and methods. Particular embodiments are directed to tablet or smartphone supports for mounting on an airplane or other vehicle seat.

### BACKGROUND

Airplane passengers make use of a variety of materials and devices to occupy their time during flight. For example, personal electronic devices (“PEDs”) are commonly used in flight as a source for entertainment and a means to complete work. A PED can be any type of electronic device a user can transport and use in a mobile environment, such as a tablet computer, notebook computer, smartphone, electronic book/electronic reader, music device, laptop computer, cellular/personal communication device, audio/video/data recording or playback device, scanning device, messaging device, personal digital assistant (PDA), or similar device. While such devices can be enjoyable and productive to use in flight, given the limited personal space allocated to individual airplane passengers, it can be difficult to use such PEDs comfortably for extended periods.

### SUMMARY

The technology in accordance with embodiments of the present disclosure provide a PED support system that overcomes drawbacks experienced in the prior art and provide other benefits. At least one embodiment provides an article support system for use with a vehicle seat assembly having a seatback portion. The article support system has an attachment portion attachable to the back portion of the seat. A support panel is pivotally coupled to the attachment portion and moveable between deployed and stowed positions. The support panel has a support surface and upper and lower edge portions adjacent to the support surface. The support panel is configured to be releasably retained in the stowed position wherein the upper and lower edge portions are substantially immediately adjacent to the seatback portion. When the support panel is in the deployed position, the upper edge portion is adjacent to the seatback portion and the lower edge portion is spaced apart from the seatback portion with the support surface facing away from the seatback portion at a selected inclined angle to support the article thereon. A restraint is connected to the support panel and is positionable relative to the support surface to releasably engage and hold the article against the support surface when the support panel is in the deployed position.

Another embodiment of the present technology provides a seat assembly comprising a seat having a seatback with a front portion and a rear portion, and a deployable article support assembly with an attachment portion securely coupled to the rear portion of the seatback. A support panel is pivotally coupled to the attachment portion and is moveable relative to the seatback between deployed and stowed positions. The support panel has upper and lower edge portions and a support surface extending therebweeen. The upper and lower edge portions are substantially immediately adjacent to the rear portion of the seatback when the support panel is in the stowed position. When the support panel is in the deployed position, the upper edge portion is adjacent to the rear portion of the seatback and the lower edge portion is spaced apart from the rear portion with the support surface facing away from the seatback at a selected inclined angle. A restraint is attached to the support panel and extends adjacent to the support surface. The restraint is adjustable to releasably engage and hold an article against the support surface when the support panel is in the deployed position.

Another embodiment provides a vehicle seat assembly comprising a seat having a seatback with a crossbar and front and rear portions. An attachment portion is securely attached to the crossbar. A support panel is pivotally coupled to the attachment portion by a resistant hinge mechanism and is moveable relative to the attachment portion between deployed and stowed positions. The support panel has a support surface and a lateral side portion adjacent to the support surface. The support panel has upper and lower edge portions on opposing sides of the support surface. The upper and lower edge portions are substantially immediately adjacent to the seatback when in the stowed position. When the support panel is in the deployed position, the lower edge portion is spaced apart from the seatback with the support surface facing away from the seatback and oriented at a selected inclined angle relative to the seatback to support a selected article thereon. A deployable support lip is attached to the lower edge portion of the support panel. A flexible restraint is attached to the support panel and extends across a portion of the support surface. The restraint is configured to releasably engage and hold the article against the support surface when the support panel is in the deployed position. A tray table assembly is operably attached to the seat and has a tray table adjacent to the seatback portion. The tray table is movable between open and closed positions relative to the seatback, and the support panel is positioned between the tray table and the seatback when the tray table is in the closed position. The support panel is moveable from the stowed position to the deployed position only when the tray table is in the open position.

### BRIEF DESCRIPTION OF THE DRAWINGS

FIG. 1 is an isometric view of a PED support system coupled to an airplane seat and configured in accordance with embodiments of the technology.

FIG. 2A is an isometric view of the support system of FIG. 1 in a partially open configuration in accordance with embodiments of the technology.

FIG. 2B is an isometric view of the support system of FIG. 1 in an open configuration in accordance with embodiments of the technology.

FIG. 3A is an isometric view of the support system of FIG. 1 in a closed configuration in accordance with embodiments of the technology.

FIG. 3B is an isometric view of the support system of FIG. 1 positioned behind an airplane seat tray table and configured in accordance with embodiments of the technology.

FIG. 4A is an isometric view of a PED support system coupled to an airplane seat and configured in accordance with another embodiment of the technology, wherein the support system is in a closed configuration (with a seat tray table deployed).

FIG. 4B is an isometric view of the PED support system of FIG. 4A in an open configuration in accordance with aspects of the technology.

FIG. 4C is a front view of the PED support system of FIG. 4A in an open configuration and supporting a tablet in accordance with aspects of the technology.

FIG. 4D is an enlarged isometric view of an embodiment of the PED support system of FIG. 4B shown in an open position and removed from the seat.

FIG. 4E is an isometric view of the PED support system of FIG. 4D shown supporting a PED.

FIG. 5A is an isometric view of a PED support system coupled to an airplane seat and configured in accordance with another embodiment of the technology, wherein the support system is in an open configuration (with a seat tray table deployed).

FIG. 5B is an isometric view of the PED support system of FIG. 5A in the open configuration and supporting a tablet in accordance with aspects of the technology.

FIG. 6A is an isometric view of a PED support system coupled to an airplane seat and configured in accordance with another embodiment of the technology, wherein the support system is in an open configuration (with a seat tray table deployed).

FIG. 6B is an isometric view of the PED support system of FIG. 6A in the closed configuration in accordance with aspects of the technology.

FIG. 6C is an enlarged isometric view of the PED support system of FIG. 6A in the open configuration and supporting a tablet in accordance with aspects of the technology.

### DETAILED DESCRIPTION

The present technology relates generally to seat-mounted supports for PEDs, and associated systems and methods. Particular embodiments are directed to tablet or smartphone supports for mounting on the vehicle seat, such as an airplane seat, train seat, bus seat, etc. In some embodiments, a support system for restraining a PED include an attachment portion, such as a first panel or a hinged engagement portion, configured for attachment to a seat. The system further includes a support panel having at least one restraining feature configured to restrain the PED against the support panel. In one embodiment, wherein the attachment portion is a first panel, a connection portion, such as a web, hinge, or intermediate panel, pivotably connects the first panel to the support panel. The system can further include complementary engagement features coupled to the support panel to adjust the angle of the support panel relative to the seat. For example, in some embodiments, the first panel can pivot between a first position parallel to the support panel and a second position non-parallel to the support panel. In another embodiment, the support panel is connected to one or more restrictive hinges that allowed the support panel to be moved to a selected position between the first and second positions, inclusive, and that will retain the support panel in the selected position until the support panel is physically engaged and moved to another position.

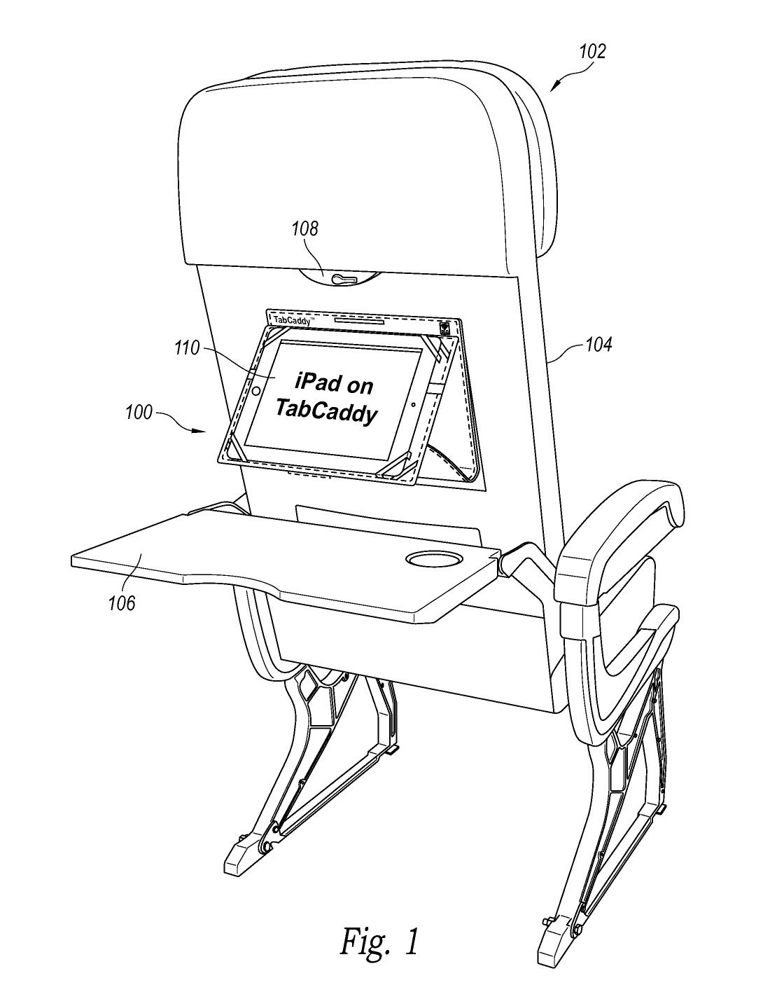

Specific details of several embodiments of the technology are described below with reference to FIGS. 1-6C. Other details describing well-known structures and systems often associated with PEDs, PED support systems, or seats have not been set forth in the following disclosure to avoid unnecessarily obscuring the description of the various embodiments of the technology. Many of the details, dimensions, angles, and other features shown in the Figures are merely illustrative of particular embodiments of the technology. Accordingly, other embodiments can have other details, dimensions, angles, and features without departing from the spirit or scope of the present technology. A person of ordinary skill in the art, therefore, will accordingly understand that the technology may have other embodiments with additional elements, or the technology may have other embodiments without several of the features shown and described below with reference to FIGS. 1-3B.

FIG. 1 is an isometric view of a PED support system 100 coupled to an airplane seat 102 and configured in accordance with embodiments of the technology. The system 100 is coupled to a back surface 104 of the seat 102 and is configured to support (e.g., securely hold) a PED 110 in one or more positions angled relative to the back surface 104 of the seat 102 and/or a horizontal plane. More specifically, the system 100 can releaseably hold the PED 110 at various angles to make using the PED more comfortable for a user sitting in a seat behind the illustrated seat 102.

Although the illustrated embodiment is shown attached to the back surface of an airplane passenger seat, the PED support system can be attached to the back portion of other seats, including train seats, bus seats, car seats, boat seats, or other vehicle seats. In yet other embodiments, the PED support system can be attached to other seats, such as theater seats, auditorium seats, lecture hall seats, classroom seats, amusement ride seats, etc. The PED support system can also be attached to other support structures adjacent to seats, such as bulkheads, partitions, walls, etc.

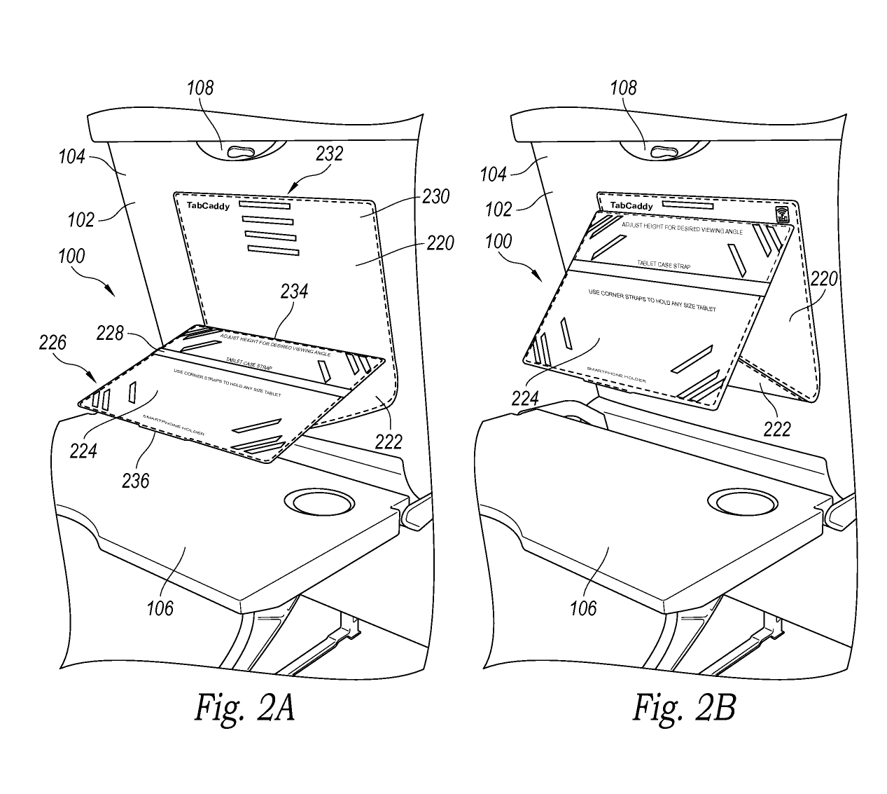

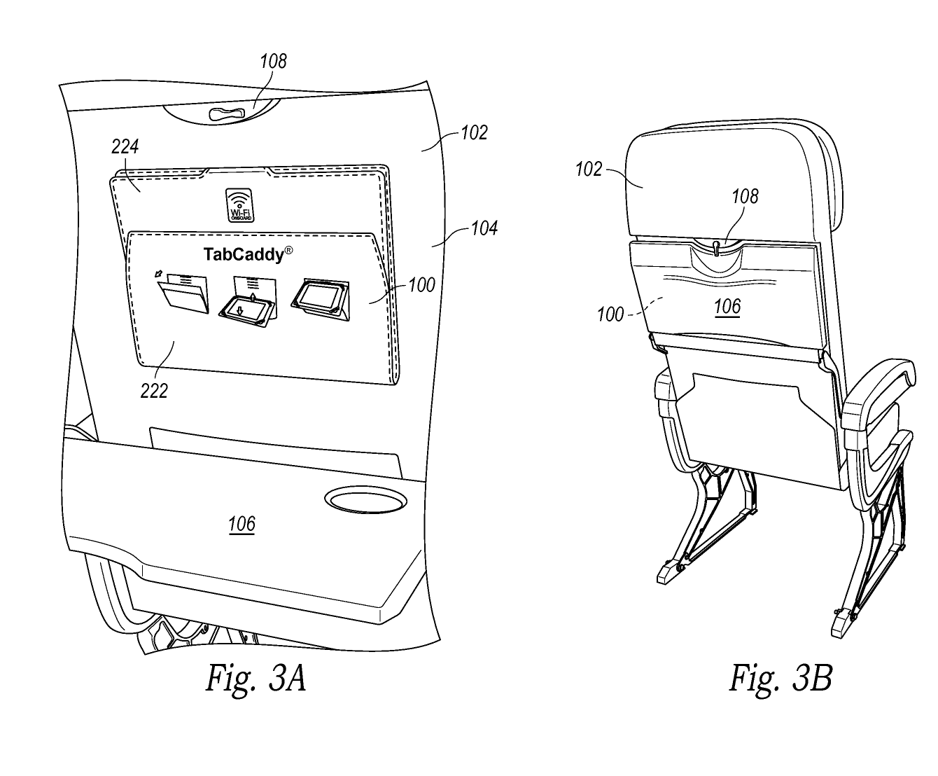

The system 100 can alternate between an open configuration (as shown in FIGS. 1-2B) and a closed configuration (as shown in FIGS. 3A and 3B). In the particular embodiment illustrated in FIG. 1A, the system 100 is positioned on the back surface 104 of the seat 102 between a tray table 106 and a tray table locking device 108. In this arrangement, as will be discussed in further detail below with reference to FIGS. 3A and 3B, the system 100 can be entirely or at least mostly hidden or locked away when the system 100 is in the closed configuration and the tray table 106 is in engagement with the tray table locking device 108. In further embodiments, the system 100 can be used on seats 102 not having a tray table 106. As will be discussed in further detail below, the system 100 can be permanently or removably attached to the seat 102.

FIG. 2A is an isometric view of the PED support system 100 of FIG. 1 in a partially open configuration in accordance with embodiments of the technology. FIG. 2B is an isometric view of the PED support system 100 in an open configuration in accordance with embodiments of the technology. Referring to FIGS. 2A and 2B together, the system 100 includes a plurality of segments or panels. For example, the illustrated system 100 includes a support panel 224 configured to hold the PED, a back panel 220 configured for attachment to the back surface 104 of the seat 102, and an intermediate panel 222 connecting the support panel 224 and the back panel 220. In some embodiments, one or more surfaces of the system 100 can be suitable for use as informational or advertising space 230, such as for an airline logo, safety instructions, etc. In various embodiments, the advertising space 230 can be visible when the system 100 is in the open and/or closed configuration.

In some embodiments, the support panel 224 and back panel 220 can be respectively pivotably coupled to the intermediate panel 222. In various embodiments, the support panel 224, intermediate panel 222, and back panel 220 can be generally flexible or generally rigid, or a combination of these properties. For example, in some embodiments, the intermediate panel 222 can be a generally flexible material that is able to bend with respect to a generally rigid support panel 224 and a generally rigid back panel 220. In some embodiments, the intermediate panel 222 is sufficiently flexible to allow pivoting relative to the support panel 224 and back panel 220 without the need for a hinge. In further embodiments, the intermediate panel 222 can be coupled to the support panel 224 and/or back panel 220 with a hinge or similar device.

In particular embodiments, the generally rigid material can comprise one or more of stiff cardboard, plastic, metal (e.g., aluminum), wood, composite materials, etc. In some embodiments, the rigid material can be covered in another material having properties suitable for attractive, functional, and/or durable use, such as leather, fabric, flexible plastic, silicone, etc. In particular embodiments, the flexible intermediate panel 222 is made of one or more of these covering materials (e.g., leather), without the rigid internal portion. In various embodiments, the back panel 220, intermediate panel 222, and/or support panel 224 can be a continuous structure, or can be separate, attached structures. While the illustrated system 100 includes three panels, in further embodiments the system 100 can include more or fewer panels in various combinations of rigid and/or flexible materials. In several embodiments, the system 100 is generally lightweight. For example, the system 100 can be substantially less than 3% of the weight of the seat 102.

The support panel 224 can be configured to support any one of a plurality of PEDs of various shapes and sizes. One or more corner areas of the support panel 224 can include one or more restraints 226 to restrain the PED against the support panel 224 without significantly blocking the useable space of the PED. In some embodiments, the restraints 226 are a flexible material configured to wrap around the corner portions of the PED. In particular embodiments, the restraints 226 are an elastic material, while in other embodiments the restraints 226 are fabric, rubber, leather, or other material. The support panel 224 can include multiple sets of restraints 226 such that PEDs of various sizes can be accommodated by the same system 100. While the restraints 226 are shown on all four corner areas of the support panel 224, in further embodiments the restraints 226 may be in only some of the corner areas. In still further embodiments, the support panel 224 can alternately or additionally include one or more restraints in positions other than the corner areas. For example, the illustrated embodiment includes a horizontal restraint 228 across the support panel 224. The horizontal restraint 228 can restrain the PED, a protective cover for the PED, or other material. For example, while the system 100 has been largely described in the context of restraining a PED, in further embodiments the system 100 can be used to support other materials or devices, such as a magazine, a newspaper, a book, a music player, etc. In further embodiments, the support panel 224 can include a vertical restraint suitable for restraining a book at its crease.

In some embodiments, the support panel 224 can further include a support lip 236 on at least one peripheral portion. In the illustrated embodiment, for example, the support lip 236 extends at least generally perpendicular to the surface of the support panel 224 at the bottom of the support panel 224 when the system 100 is oriented in the open configuration. The support lip 236 can hold a PED, whether or not the PED is otherwise restrained by the restraints 226, 228. In further embodiments, the support lip 236 can comprise a more substantial edge, such as a shelf, to support a larger PED or other object such as a book. In various embodiments, the support lip 236 can be fixed to the support panel 224 or can move relative to the support panel 224 (e.g., can flip or slide out from the support panel 224).

The support panel 224 can releaseably interface with the back panel 220. In some embodiments, for example, the support panel 224 and back panel 220 can each include complementary engagement features. For example, the support panel 224 can include a support panel engagement feature 234, such as a hook, clip structure, or the like, extending from the top surface of the support panel 224 when the system 100 is in the open configuration. The back panel 220 can include one or more back panel engagement features 232, such as slots, into which the support panel engagement feature 234 interfaces. The hook-and-slot interface holds the support panel 224 at an angle relative to the back panel 220 and the horizontal plane. The illustrated embodiment includes four slots on the back panel 220 at different distances from the top edge of the back panel, such that the plurality of slots provide different angles of the potential support panel 224 relative to the back panel when the system is in the open configuration. A user can select a suitable slot to provide comfortable use of a PED attached to the support panel 224. In further embodiments, the back panel 220 can include more or fewer back panel engagement features 232 at the same or different positions on the back panel 220. The support panel 224 can be adjusted to maintain a comfortable position of the support panel 224 for that user. For example, if the seat 102 is reclined in a manner that affects the angle or position of the back panel 220, thereby affecting the angle of the support panel 224 relative to the PED user, the angular orientation of the support panel 224 can be readjusted (e.g., engaged at a different back panel engagement feature 232) to re-attain a comfortable position for the user to interact with the PED. In further embodiments, the angle of the support panel 224 can be selected by resting the bottom of the support panel (e.g., proximate to the support lip 236) on the tray table 106. In some embodiments, the support panel 224 can be positioned at a height and incline to act as an extension of the functional space of the tray table 106.

In some embodiments, the support panel engagement feature 234 can automatically disengage from the back panel engagement features 232 when the tray table 106 is pushed into a locked configuration (e.g., locked to engage with the tray table locking device 108). More specifically, closing the tray table 106 (pushing the table upward against the seat 102) can lift the support panel 224 and cause the support panel engagement feature 234 to disengage (e.g., unhook) from the back panel engagement feature 232. Thus, when the tray table 106 needs to be quickly moved to the locked position (such as during takeoff, landing, or in an emergency situation), the system 100 does not interfere with or slow down such locking.

In various embodiments, the back panel 220 can be permanently or removably attached to the seat 102. The back panel 220 can be attached to the seat 102 with any type of fastener, such as rivets, screws, stitching, hook-and-eye, snaps, adhesive, magnets, etc. In some embodiments, the back panel 220 can be locked to the seat 102 such that a professional (e.g., a flight attendant, maintenance crew member, etc.) can unlock the system 100 from the seat 102 but a user (e.g., a passenger) cannot. In a particular embodiment, a portion of the back panel 220 can be positioned between the tray table locking device 108 and the seat 102, such that the same fastener that attaches the tray table locking device 108 to the seat 102 attaches the system 100 to the seat 102. Thus, the system 100 can be replaced by detaching the tray table locking device 108 from the seat, replacing the system 100, and reattaching the tray table locking device 108. In some embodiments, the system 100 can be quickly and readily replaced if necessary, such as between flights. In various embodiments, the system 100 can be used with a new seat 102 or can be retrofitted to an existing seat 102. In some embodiments, the system 100 is integral to the seat 102.

As will be discussed in further detail below with reference to FIGS. 3A and 3B, the system 100 can be adjusted from the open configuration to the closed configuration by pivoting the support panel 224 at the intermediate panel 222 toward the back panel 220, such that the PED supporting surface of the support panel 224 faces the seat 102. FIG. 2A illustrates the system 100 at an intermediate position between fully open and fully closed. In some embodiments, the support panel 224 and/or back panel 220 can include fasteners to maintain the system 100 in the closed configuration. In various embodiments, for example, the support panel 224 and/or back panel 220 can include complementary or interfacing magnets, rivets, hook-and-eye fastener, snaps, etc.

FIG. 3A is an isometric view of the PED support system 100 in a closed configuration in accordance with embodiments of the technology. FIG. 3B is an isometric view of the PED support system 100 positioned behind the tray table 106 and configured in accordance with embodiments of the technology. As described above and shown with reference to FIG. 3A, the system 100 can be moved to the closed configuration by pivoting the support panel 224 at the intermediate panel 222 toward the back surface 104 of the seat 102. The support panel 224 can be releaseably engaged with the back panel 220 (shown in FIGS. 1-2B) and restrained in a position parallel to the back surface 104 of the seat 102 with any type of releasable fastener. When the system 100 is in the closed configuration, a PED held by the support panel 224 can be sandwiched between the support panel 224 and the back panel 220. In some embodiments, a soft material covering the back panel 220 and support panel 224 can protect the PED from damage (e.g., scratches) when the system 100 is in the closed configuration. As shown in FIG. 3B, the system 100 in the closed configuration can fit at least substantially behind the tray table 106 when the tray table 106 is in the locked arrangement (e.g., engaged with the tray table locking device 108). Thus, the system 100 is secured during takeoff and landing without affecting seat functionality.

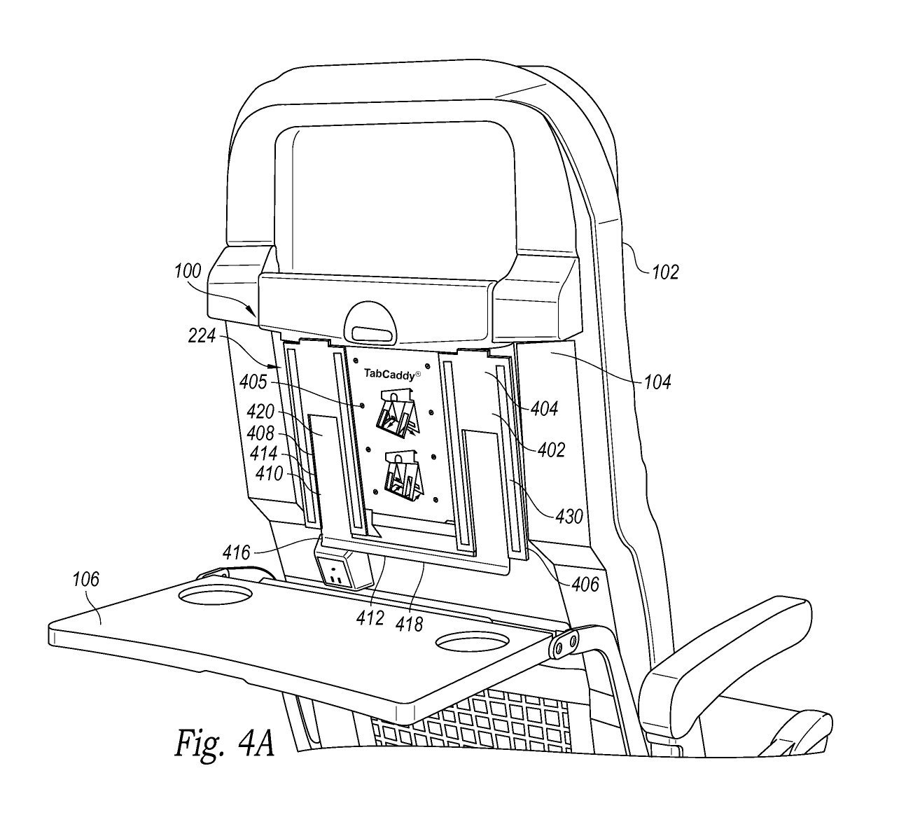

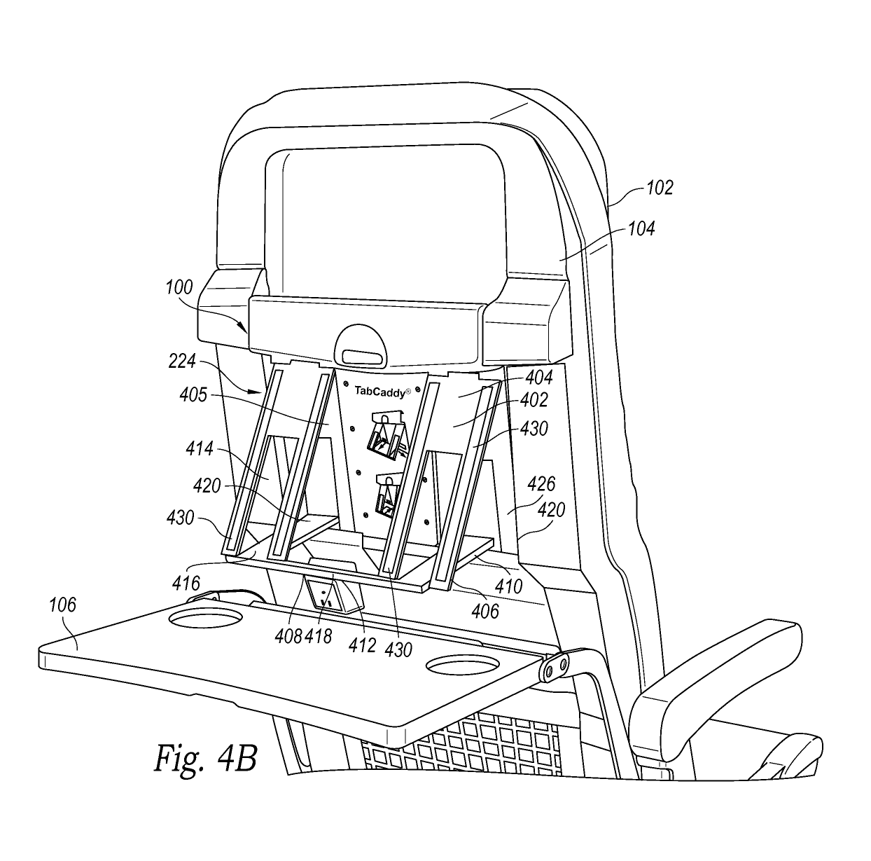

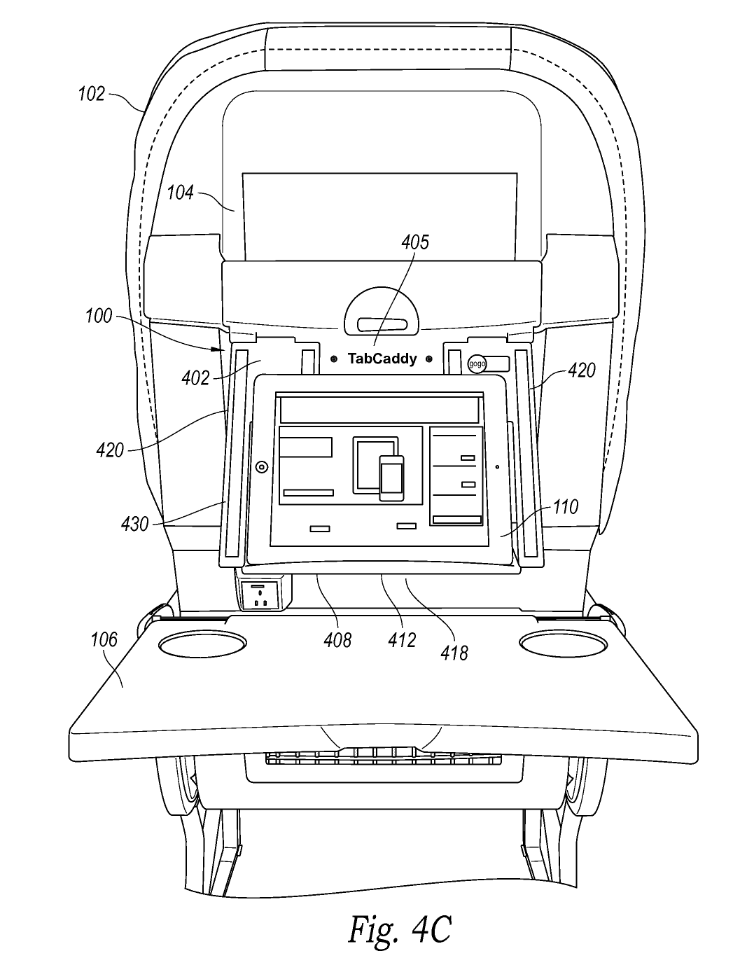

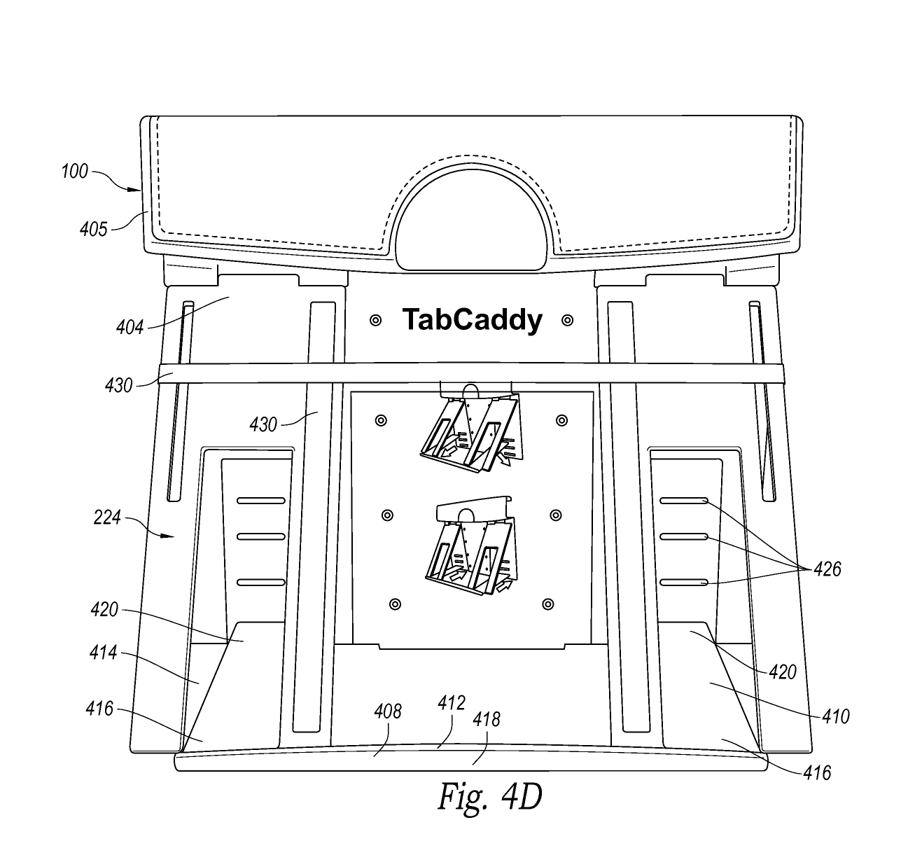

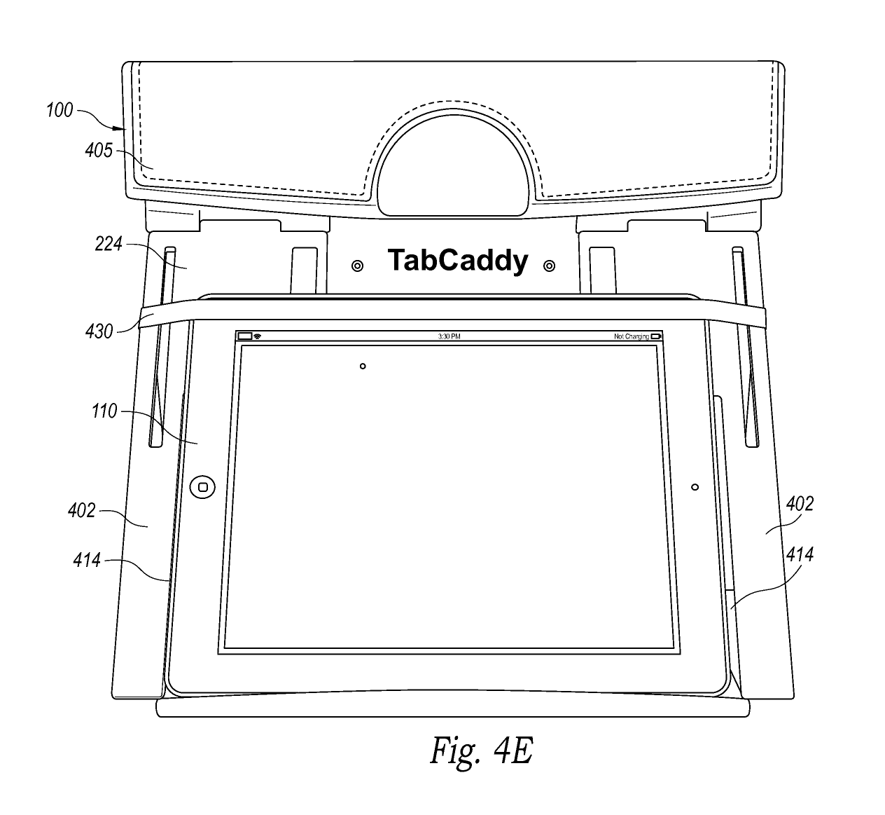

FIG. 4A is an isometric view of a PED support system 100 in accordance with another embodiment, wherein the support system is shown in a closed configuration and the seat tray table 106 is shown deployed. FIG. 4B is an isometric view of the PED support system 100 of FIG. 4A in an open configuration, and FIG. 4C is a front view of the PED support system 100 of FIG. 4B in the open configuration and supporting a PED 110 in accordance with aspects of the technology. FIG. 4D is an enlarged isometric view of an embodiment of the PED support system of FIG. 4B shown in an open position and removed from the seat. FIG. 4E is an isometric view of the PED support system of FIG. 4D shown supporting a PED. In the illustrated embodiment, the support panel 224 is a two-piece panel with spaced apart planar panel portions 402 each pivotally attached at its upper end portion 404 to the back panel 405. In another embodiment, the support panel portions 402 can be pivotally attached at their upper end portions 404 directly to the seat 102, such as at the seat's back surface 104. In another embodiment, the support panel portions 402 can be independent panel portions or they can be interconnected by a cross brace or other interconnecting structure spanning between the support panel portions 402. In the illustrated embodiment, the support panel portions 402 can be metal (e.g., aluminum or the like), plastic, composite, or other suitably stiff and/or rigid material(s).

The bottom portion 406 of each support panel portion 402 is pivotally attached to an intermediate panel 408. The intermediate panel 408 of the illustrated embodiment is a generally U-shape structure with a pair of spaced-apart engagement legs 410 interconnected by a cross member 412. When the illustrated PED support system 100 is in the closed position, as illustrated in FIG. 4A, the intermediate panel 408 is substantially coplanar with the support panel portions 402, wherein each of the engagement legs 410 is disposed in an elongated slot 414 formed in the support panel portions 402. The bottom portion 416 of each engagement leg 410 (generally adjacent to the cross member 412) is pivotally attached to the bottom portion 406 of the support panel portions 402. In the illustrated embodiment, each engagement leg 410 is connected to the respective support panel portion 402 with a pivot pin or other hinge or hinge-like structure.

The upper end portions 420 of the engagement legs 410 are substantially coplanar with the slots 414 in the support panel portions 402 and roughly parallel to the back panel 405 or the seat's back surface 104 when the PED support system 100 is in the closed position. The upper end portions 420, however, are free to move relative to the slots 414 as the PED support system 100 moves between the closed and open positions. As the PED support system 100 moves away from the closed position toward the open position, as shown in FIGS. 4B and 4C, the support panel portions 402 pivot about their respective upper end portions 404, such that the bottom portions 406 of the support panel portions 402 move away from the back panel 405 or the back of the seat 102. During this pivoting motion, the cross member 412 of the intermediate panel 408 also moves away from the back panel 405 while the intermediate panel 408 pivots about the bottom portion 416 of the engagement legs 410, such that the upper end portions 420 of the engagement legs 410 remain substantially adjacent to the back panel 405 at the seat's back surface 104.

In the illustrated embodiment, the upper end portions 420 of the engagement legs 410 have a hook-shape or other engagement shape configured to engage portions of the back panel 405. The back panel 405 has a plurality of slots 426 or other engagement features aligned with the engagement legs 410 of the intermediate panel 408. The slots 426 are vertically spaced and configured to allow the engagement legs to hook into the slots or other engagement features to hold the intermediate panel 408 at a selected angular orientation, thereby retaining the support panel portions 402 at a selected slanted or angled orientation for retaining the PED thereon when the PED support system 100 is in an open position. The illustrated embodiment includes a set of three vertically distributed slots aligned with each of the engagement legs to allow the user to position the support panel portions 402 in one of three slanted, open positions. The cross member 412 of the illustrated embodiment has a support shelf or shoulder 418 that can support the PED when the PED support system is in the open position (FIGS. 4B, 4C, and 4D). The support shelf or shoulder 418 of the cross member 412 provides a structure against which the bottom of a PED or other device can rest or engage when the PED support system 100 is in the open position.

While the illustrated embodiment has sets of three vertically oriented slots 426 for each engagement leg 410 to provide a plurality of angular orientations of the PED support system 100 when in the open position, other embodiments can have additional slots so as to correspond to other open positions with different angular orientations. In yet another embodiment, the intermediate panel 408 can engage the back panel in any one of a variety of positions to provide a full range of angular orientations of the support panel portions 402 when the PED support system 100 is in the open position. When the PED support system 100 is in the closed position, the intermediate panel 408 and support panel portions 402 are immediately adjacent to the back panel 405 and substantially coplanar so as to allow the tray table 106 to move to its full upright and locked position, such as during takeoff and landing.

In the illustrated embodiment, the support panel portions 402 include a plurality of restraints 430 configured to engage and retain the PED 110 or other item against the support panel portions 402 when in the open position. In the illustrated embodiment, the restraints 430 are elastic straps, although other embodiments can use other retention mechanisms or straps for releasably retaining the PED in a desired position when the PED support system 100 is in the open position. In the illustrated embodiment, the restraints 430 include a pair of “vertical” straps aligned with the support panel portions 402 such that the PED can be positioned between the vertical straps and the intermediate panel portions 402. The restraint 430 of the illustrated embodiment can also include one or more “horizontal” straps, as shown in FIGS. 4D and 4E, configured to releasably engage the PED device. The horizontal strap can be, as an example, a loop of elastic or stretchable material that extend through a pair of elongated slots or other apertures. Accordingly, the “vertical” position of the strap can be adjusted along the length of the slots to fit over PEDs of various sizes. In yet other embodiments, straps can be provided with different orientations, lengths, and/or positions. In yet other embodiments, other retention mechanisms can be used to releasably engage and hold the PED or other item in place when the PED support system 100 is in the open position, while allowing the item to be easily and quickly removed when the PED support system 100 is to be moved to the closed position.

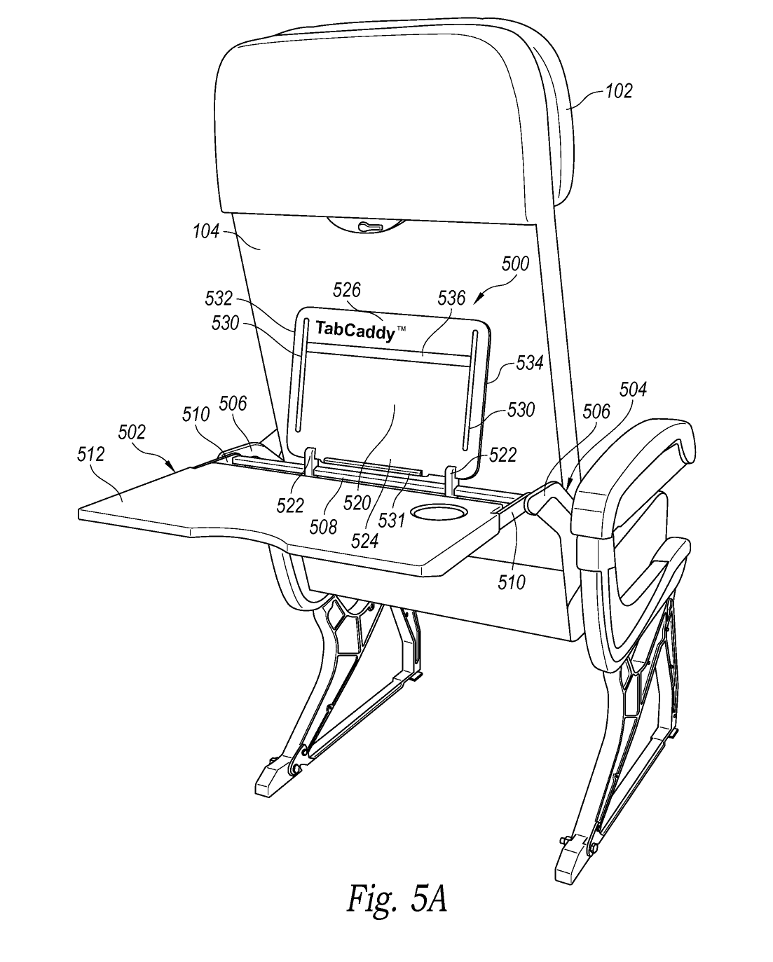

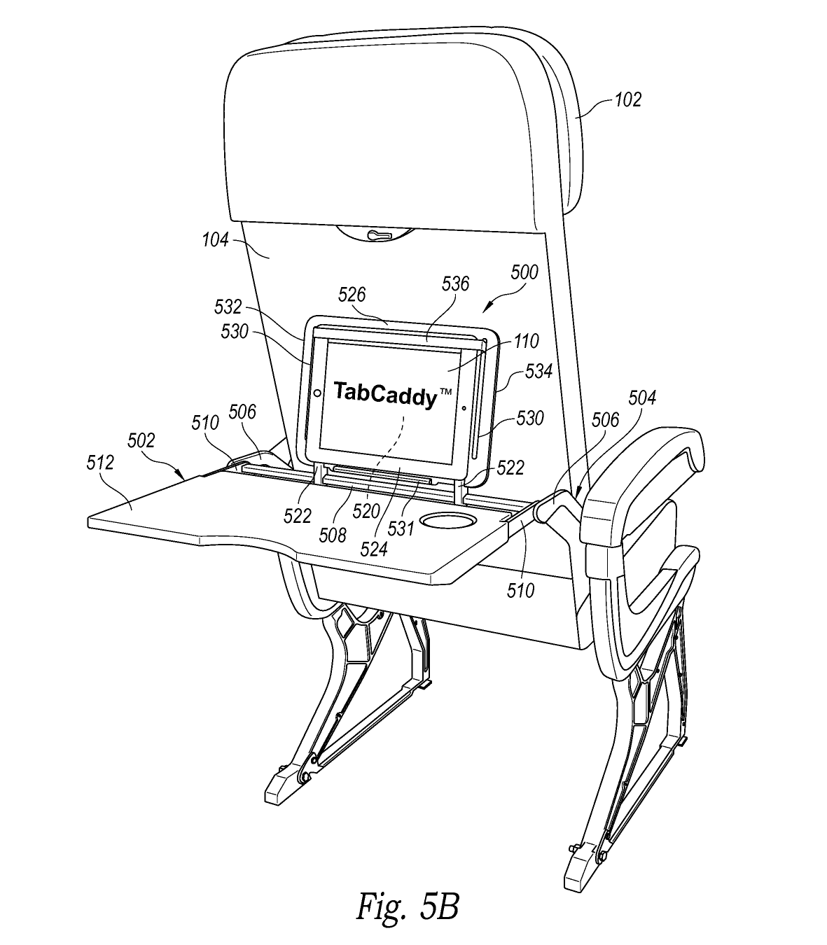

FIGS. 5A and 5B are isometric views of a PED support system 500 coupled to an airplane seat 102 and configured in accordance with another embodiment of the technology. The PED support system 500 of the illustrated embodiment is connected to a tray table assembly 502 pivotally mounted to the seat 102. The tray table assembly 502 has a frame 504 with a pair of spaced apart attachment portions 506 pivotally connected to the seat 102, and a crossbar 508 spans generally horizontally between the attachment portions 506. A pair of tray support bars 510 project from the attachment portions 506 away from the seat's back surface 104, and a tray table 512 is carried by the tray support bars 510. In some embodiments, the tray table 512 is slidably disposed on the tray support bars 510 for linear movement toward or away from the seatback 104.

The illustrated PED support system 500 has a planar support panel 520 attached to the crossbar 508 with a pair of spaced apart mounting brackets 522. The mounting brackets 522 can be integrally connected to the crossbar 508 or fixedly attached with fasteners (with security heads) or the like that allow the PED support system 500 to be retrofit onto a tray table assembly of an existing seat. In one embodiment, the mounting brackets 522 can be connected to the crossbar 508 so as to allow the planar support panel 520 to be laterally adjustable relative to the crossbar 508 by a person using the PED support system 500. The mounting brackets 522 can be attached to a bottom edge portion 524 of the support panel 520. The support panel 520 can be coupled to the crossbar 508 in hinged or pivotally arrangement that allows for adjustment of the support panel 520, such as when a passenger in the seat 102 reclines the seatback. In one embodiment the support panel 520 is attached to the crossbar 508 with a multi-axis hinge that allows the support panel 520 to move about two or more axes of rotation relative to the crossbar 508. Accordingly, the multi-axis hinges allow the support panel 520 to tilt toward or away from the seatback 104, and also allow the bottom edge portion of the support panel to swing toward or away from the seatback. This configuration allows the support panel 520 to swing closer to the user when in use and to swing into close alignment with the seatback 104, such as when the tray table is closed. Other embodiments can use multi-axis mounting members that allows for multi-axis adjustability of the support panel 520 relative to the seat 102.

In the illustrated embodiment, a support rail 531 projects from the bottom edge portion 524 and extends laterally between the mounting brackets 522. The support rail 531, as shown in FIG. 5B, is configured to support the PED 110 when the tray table assembly 502 is in the open or deployed position. In this position, the bottom edge portion 524 of the support panel 520 is spaced away from the seat's back surface 104 such that the support panel 520 can be tilted with its top edge portion 526 connected to or otherwise positioned adjacent to the back surface 104. This tilted arrangement of the support panel 520 provides an upright surface that also acts to support and hold the PED 110 in an upright position to allow the user to easily access and see the device.

The illustrated PED support system 500 has one or more retention members attached to the support panel 520 and configured to releasably hold the PED 110 against the support panel 520. In the illustrated embodiment, the support panel 520 has a pair of spaced apart elongated slots 530 in the left and right side portions 532 and 534 that extend generally between the top and bottom edge portions 526 and 524. A retention strap 536 is connected to the support panel 520 and is positionable to releasably engage the PED 110 (FIG. 5B) and hold the device against the support panel 520. The illustrated retention strap 536 is an elastic band that extends through the elongated slots 530 and spans across the support panel 520 between the slots 530. The elastic retention strap 536 can be moved relative to the support panel 520 along the length of the slots 530 so as to adjust the position of the strap to fit over and hold the PED 110 in place on the support panel. While the illustrated embodiment shows one elastic strap, the PED support system 500 in other embodiments can include a plurality of straps or other PED retention members attached to the planar support panel 520. Further, while the illustrations show only one pair of spaced apart elongated slots 530, the support panel 520 in other embodiments can be configured with a plurality of slots or retention features having retention members coupled thereto in configurations that allow PEDs of different shapes and sizes or other items to be securely yet releasably held to the support panel 520 during use of the system.

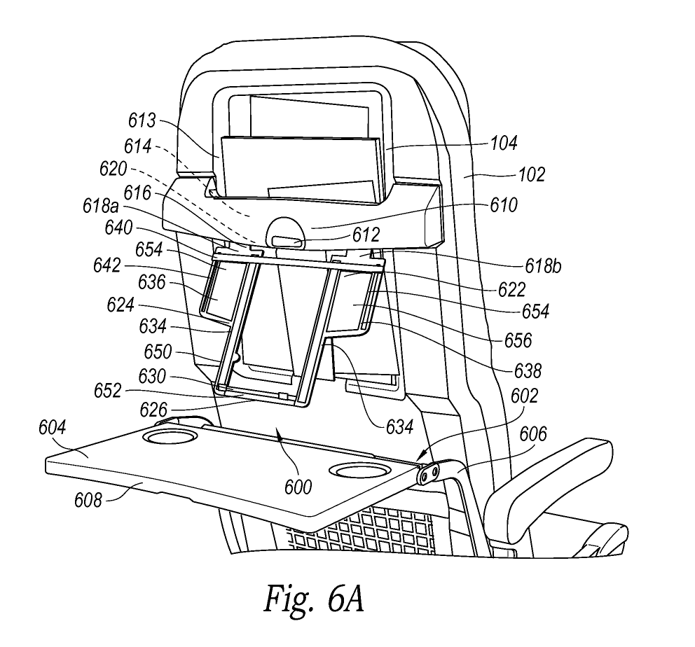

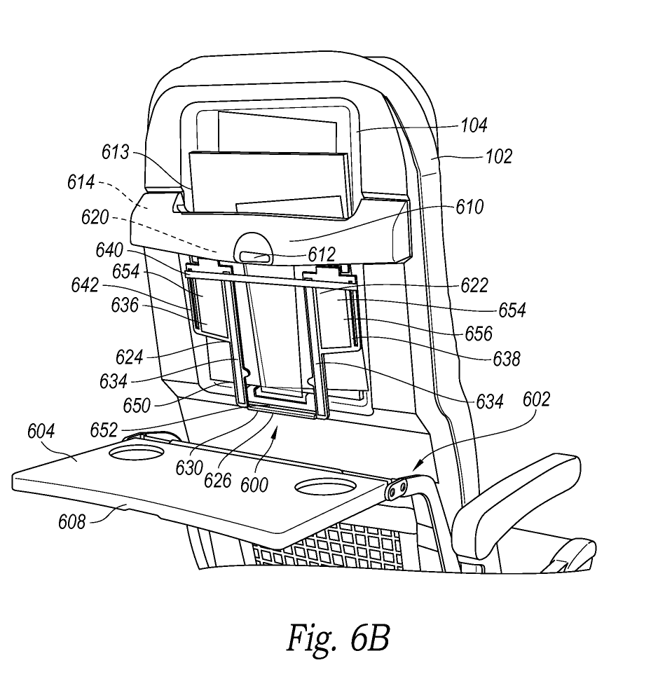

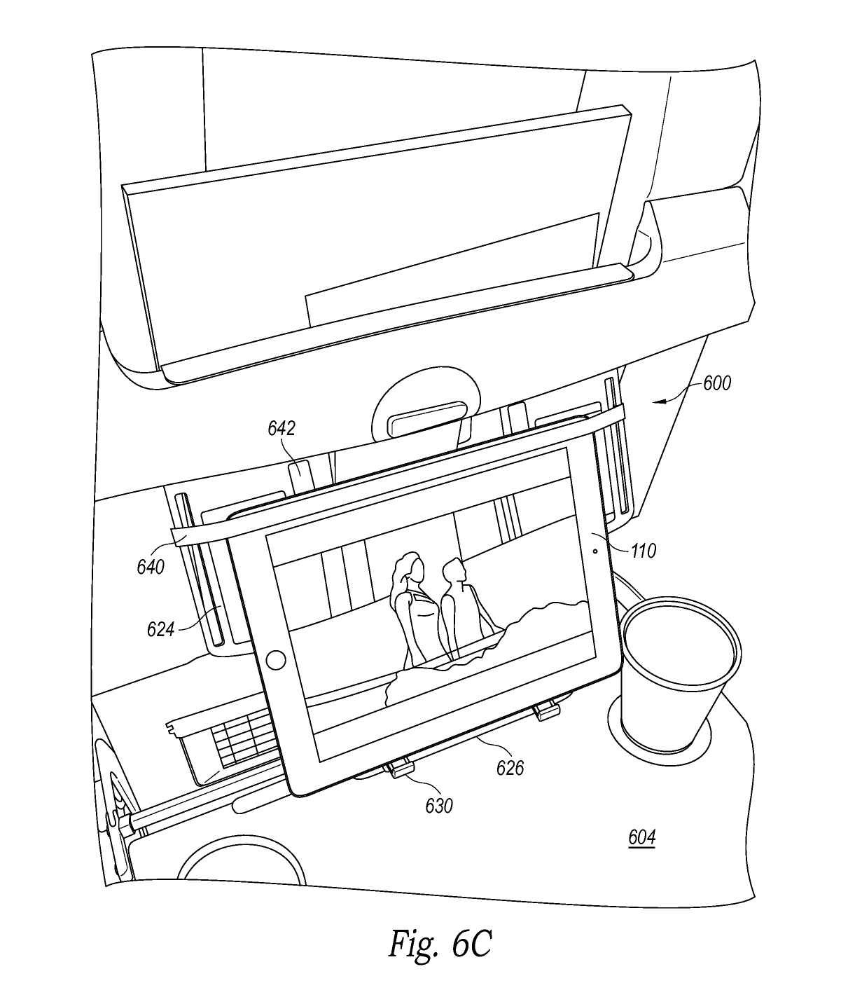

FIGS. 6A-6C are isometric views of a PED support system 600 coupled to an airplane seat 102 and configured in accordance with another embodiment of the technology. The PED support system 600 of the illustrated embodiment is coupled to the back of the seat 102 generally adjacent to a tray table assembly 602 substantially similar to the tray table assembly 502 disclosed above in connection with FIGS. 5A and 5B, wherein the tray table assembly has a tray table 604 pivotally carried by tray support bars 606. The tray table 604 is moveable relative to the seat 102 between a lowered, open position, as shown in FIG. 6A, and a raised, closed position. The tray table 604 has a free end 608 spaced away from the back surface 104 of the seat 102 when the tray table 604 is in the lowered, open position. When the tray table 604 is in the raised, closed position, the tray table's free end 608 is releasably engaged (or engagable) by a tray table locking assembly 610 with a latch mechanism 612 that releasably retains the tray table 604 in the raised, closed position. In the illustrated embodiment, the tray table locking mechanism 610 is integrally coupled to a high pocket assembly 613 that defines a pocket portion on the seatback to retain selected items, such as informational pamphlets, magazines, reading material, etc. The high pocket assembly 613 is coupled to a cross member, such as a horizontal crossbar 614 (shown in broken lines) attached to the back of the seat 102. In the illustrated embodiment the crossbar 614 is a bridge or T-bar structure of the seat 102.

The illustrated PED support system 600 has a mounting assembly 616 fixed to the crossbar 614 so as to attach the PED support system 600 to the back of the seat. In one embodiment, the mounting assembly 616 can be releasably attached to the crossbar 614 with securing mechanisms, such as fasteners or via a friction fit that securely holds the PED support system 600 in place, while allowing the system to be removed and replaced. The PED support system 600 may be attached to the back of the seat 102 during the original manufacture of the seat 102, or it may be installed on the seat 102 in a retrofit arrangement. In one embodiment, the mounting assembly 616 includes spaced-apart left and right mounting portions 618a and 618b, and each mounting portion is attached to a respective hinge mechanism 620. The hinge mechanisms 620 are attached to an upper portion 622 of a substantially planar support panel 624 and configured to allow the support panel 624 to pivot via the hinge mechanisms 620 relative to the back surface 104 of the seat 102. The support panel 624 has a free lower portion 626 spaced apart from the upper portion 622 and generally adjacent to the tray table 604 when the tray table is in the lowered, open position.

The upper portion 622 and the hinge mechanisms 620 are configured to allow the support panel 624 to pivotally move relative to the back surface 104 of the seat 102 (when the tray table is in the lowered, open position) between a fully deployed position (shown in FIGS. 6A-6C) and a stowed position, and to intermediate deployed positions therebetween. When the support panel 624 is in the fully deployed position and/or the intermediate deployed positions, the free lower portion 626 is spaced away from the back surface 104 of the seat 102 so the support panel 624 is tilted at an angle relative to the seat 102. This tilted arrangement of the support panel 624 provides a surface that can support and hold the PED 110 (FIG. 6C) in an upright position to allow the user to easily see and access the device. In the illustrated embodiment, a support rail 630 projects from the free lower portion 626 of the support panel 624 and is configured to support the bottom of the PED 110 when the tray table assembly 602 is in the lowered, open position and the support panel 624 is in the deployed position. When the support panel 624 is in the stowed position, the free lower portion 626 is immediately adjacent to the back surface 104 of the seat 102 so the support panel 624 is generally parallel to or aligned with the back of the seat 102 so as to allow the tray table 604 to move to the raised, closed position and held in that position by the latch mechanism 612.

In the illustrated embodiment, the hinge mechanisms 620 are restrictive hinges configured to allow a user to position the support panel 624 at substantially any selected position between the deployed and stowed positions, and the support panel 624 will remain in place until forceably moved out of the selected position. Accordingly, the PED support system 600 does not need additional supports or retention members attached to the free lower portion 626 of the support panel 624 to hold the support panel 624 in a deployed position (i.e., the fully deployed position or any intermediate deployed position). In at least one embodiment, the restrictive hinges have a frictional retention arrangement that requires a force in the range of approximately 2-8 pounds, inclusive, and preferably in the range of approximately 4-6 pounds, inclusive, to pivot the hinges, thereby pivoting the support panel 624. Accordingly, the restrictive hinge mechanisms allow a tablet, phone, other selected PED, or other items of similar weight to be supported on the support panel 624 when in any deployed potion. Other embodiments can use restrictive hinge mechanisms 620 that require a greater force or a lesser force to initiate movement of the hinges and the support panel. In yet other embodiments, other hinge mechanisms or pivoting mechanisms can be used to allow the support panel to move between the stowed and delete deployed positions and to allow the support panel to remain in the selected deployed position.

The illustrated PED support system 600 has one or more retention members 632 attached to the support panel 624 and configured to releasably hold the PED 110 (FIG. 6C) against the support panel 624. In the illustrated embodiment, the support panel 624 has a pair of spaced apart vertical slots 642 in the left and right side portions 636 and 638, and a horizontal retention strap 640 is connected to the support panel 624 and is positionable to releasably engage the PED 110 (FIG. 6C) and hold the device against the support panel 624. The horizontal retention strap 640 can be moved relative to the support panel 624 along the length of the slots 642 so as to adjust the vertical position of the strap to fit over and hold the PED 110 in place on the support panel. The support panel 624 of the illustrated embodiment also has one or more vertically arranged retention straps 634 extending generally between the upper and lower end portions 622 and 626. The vertical straps 634 are positioned to fit over a PED 110, such as adjacent to one or more vertical edges of the PED 110 to releasably retain the PED 110 on the support panel 624 without substantially blocking a user's view of a display on the PED. The illustrated retention straps 640 and 634 are elastic bands, although other embodiments can use other retention devices to releasably retain the PED 110 and on the support panel 624, such as when the support panel 624 is in a deployed position. Further, while the illustrations show the horizontal retention strap 640 as adjustably along the slots 642, other embodiments can include adjustment slots for the vertical retention straps that allow a user to move the straps relative to the support panel 624 to releasably retain PEDs or other selected items of different shapes and sizes on the support panel 624 during use of the system.

In the illustrated embodiment, the support panel 624 is a lightweight panel having a pair of spaced apart vertical members 650 interconnected at the bottom portion by a lower cross member 652 to which the support rail 630 is attached. Each vertical member 650 has a lateral wing portion 654 to which the horizontal retention strap 640 is attached. In the illustrated embodiment, the wing portions 654 are shorter than the vertical members 650 and are adjacent to the upper portion 622 of the support panel 624. In other embodiments, the wing portions 654 can be the same height as the vertical members 650. Alternatively, the wing portions 654 can be shorter adjacent to the lower cross member 652 or in an intermediate position between the upper portion 622 and the lower cross member. The wing portions 654 are configured to provide a space in which information, such as text and/or images, can be placed so as to be very visible to a user when the tray table 604 is in the open, lowered position and the support panel is in the stowed or deployed position. The wing portions 654 can be used to provide instructional information passengers. In another embodiment, the wing portions 654 can include advertising and/or promotional material that will be viewed by the passenger when he/she opens the tray table 604. The wing portions 654 can be configured to receive thin inserts 656 that display the selected information (instructional, promotional, advertising, etc.) to the passenger, such that the inserts 656 can be removed and replaced with other inserts. Such inserts 656 may be secured to the wing portions 654 by adhesive, frictional engagement, lamination, or other common retention techniques.

The technology disclosed herein offers several advantages over traditional PED support systems. For example, the present technology allows passengers to comfortably use their PEDs and other materials without requiring assistance from an outside operator, such as a flight attendant. Further, the PED support systems described herein can be lightweight and easy to attach and replace on airplane seats. The support systems can be simple to use without changing or impacting the functionality or safety features of the airplane seat or tray table.

From the foregoing it will be appreciated that, although specific embodiments of the technology have been described herein for purposes of illustration, various modifications may be made without deviating from the spirit and scope of the technology. Further, certain aspects of the new technology described in the context of particular embodiments may be combined or eliminated in other embodiments. Moreover, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

We claim:

1. An article support system for use with a vehicle seat assembly having a seatback portion, the system comprising:
an attachment portion attachable to the back portion of the seat;
a support panel having a support surface and upper and lower edge portions adjacent to the support surface, the support panel being pivotally coupled to the attachment portion and moveable between deployed and stowed positions, the support panel configured to be releasably retained in the stowed position wherein the upper and lower edge portions are substantially immediately adjacent to the seatback portion, and when the support panel is in the deployed position the upper edge portion is adjacent to the seatback portion and the lower edge portion is spaced apart from the seatback portion, with the support surface facing away from the seatback portion at a selected inclined angle to support the article thereon; and
a restraint connected to the support panel and positionable relative to the support surface to releasably engage and hold the article against the support surface when the support panel is in the deployed position.

2. The article support system of claim 1 wherein the upper edge portion is pivotally attached to the attachment member.

3. The article support system of claim 1 wherein the attachment portion comprises at least one restrictive hinge mechanism coupled to the support panel and configured to retain the support panel in the deployed position and an intermediate position between the deployed and stowed positions.

4. The article support system of claim 1 wherein the attachment portion is a back panel having a first engagement feature, and the support panel has a second engagement feature that releasably engages the first engagement feature to hold the support panel in the deployed position.

5. The article support system of claim 1 wherein the support panel has a receiving area adjacent to the support surface, and further comprising an insert member with informational indicia thereon, the insert member being removably retained in the receiving area and visible when the support panel is in the deployed position.

6. The article support system of claim 1 wherein the restraint is a flexible strap attached to the support panel, and the flexible strap extends across a portion of the support surface in a position to engage and retain the article against the support surface.

7. The support system of claim 1 wherein the restraint is laterally movable relative to the support surface.

8. The article support system of claim 1 wherein the restraint is a movable first restraint extending across a first portion of the support surface, and further comprising a movable second restraint spaced apart from the first restraint and extending across a second portion of the support surface, wherein the first and second restraints are movable relative to the support surface to releasably hold the article against the support surface.

9. The article support system of claim 1 further comprising a deployable support lip attached to the lower edge portion of the support panel.

10. A seat assembly, comprising:
a seat having a seatback with a front portion and a rear portion; and
a deployable article support assembly, comprising
an attachment portion securely coupled to the rear portion of the seatback;
a support panel pivotally coupled to the attachment portion and moveable relative to the seatback between deployed and stowed positions, the support panel having upper and lower edge portions and a support surface extending therebetween, the upper and lower edge portions being substantially immediately adjacent to the rear portion of the seatback when the support panel is in the stowed position, and when the support panel is in the deployed position the upper edge portion is adjacent to the rear portion and the lower edge portion is spaced apart from the rear portion, with the support surface facing away from the seatback at a selected inclined angle; and
a restraint attached to the support panel and extending adjacent to the support surface, the restraint being adjustable to releasably engage and hold an article against the support surface when the support panel is in the deployed position.

11. The seat assembly of claim 10, further comprising a deployable tray table coupled to the seatback, the tray table being movable relative to the rear surface of the seatback between open and closed positions, the tray table in the closed position being generally parallel to the rear surface with the support panel positioned between the tray table and the rear portion of the seatback, and the tray table in the open position extending away from the seatback and exposing the support panel and allowing the support panel to move between the deployed and stowed positions.

12. The seat assembly of claim 10 wherein the seatback has a frame structure, and the attachment portion of the article support assembly is connected to the frame structure.

13. The seat assembly of claim 12, wherein the frame structure has a crossbar spanning across a portion of the seatback, and the attachment portion is connected to the crossbar.

14. The seat assembly of claim 10, further comprising a tray table assembly with a deployable tray table assembly moveable between open and closed positions, and wherein the article support assembly is positioned above the tray table, and the support panel is configured to automatically move to the stowed positions when the tray table is moved to the closed position.

15. The seat assembly of claim 10, wherein the seat assembly is a vehicle seat.

16. The seat assembly of claim 10 wherein the upper edge portion is pivotally attached to the attachment member.

17. The seat assembly of claim 10 wherein the attachment portion comprises at least one restrictive hinge mechanism coupled to the support panel and configured to retain the support panel in the deployed position and an intermediate position between the deployed and stowed positions.

18. The seat assembly of claim 10 wherein the support panel has a receiving area adjacent to the support surface, and further comprising an insert member with informational indicia thereon, the insert member being removably retained in the receiving area and visible when the support panel is in the deployed position.

19. The seat assembly of claim 10 wherein the restraint is a flexible strap attached to the support panel, and the flexible strap extends across a portion of the support surface in a position to engage and retain the article against the support surface.

20. A vehicle seat assembly, comprising:
a seat having a seatback with a crossbar and front and rear portions;
an attachment portion securely attached to the crossbar;
a support panel pivotally coupled to the attachment portion by a resistant hinge mechanism and moveable relative to the attachment portion between deployed and stowed positions, the support panel having a support surface and a lateral side portion adjacent to the support surface, the support panel having upper and lower edge portions on opposing sides of the support surface, the upper and lower edge portions configured being substantially immediately adjacent to the seatback when in the stowed position, and when the support panel is in the deployed position the lower edge portion is spaced apart from the seatback with the support surface facing away from the seatback and oriented at a selected inclined angle relative to the seatback to support a selected article thereon;
a deployable support lip attached to the lower edge portion of the support panel;
a flexible restraint attached to the support panel and extending across a portion of the support surface, the restraint being configured to releasably engage and hold the article against the support surface when the support panel is in the deployed position; and
a tray table assembly operably attached to the seat and having a tray table adjacent to the seatback portion, the tray table being movable between open and closed positions relative to the seatback, and wherein the support panel is positioned between the tray table and the seatback when the tray table is in the closed position, and the support panel being moveable from the stowed position to the deployed position only when the tray table is in the open position.
